(19) United States
(12) Patent Application Publication
(10) Pub. No.: US 2024/0355553 A1
(43) Pub. Date: Oct. 24, 2024

(54) VARIABLE CAPACITOR

(71) Applicant: Atomica Corp., Goleta, CA (US)

(72) Inventors: Soheil Seena Partokia, San Diego, CA (US); Brian Maertz, Santa Barbara, CA (US); Dillon Acker-James, Goleta, CA (US)

(21) Appl. No.: 18/303,691

(22) Filed: Apr. 20, 2023

(51) Int. Cl. H01G 5/16; H01G 5/38

(52) U.S. Cl. CPC H01G 5/16; H01G 5/38

(57) ABSTRACT

A microelectromechanical systems (MEMS) capacitor device includes a movable plate movable between an open position and a closed position by an electrostatic force and/or a magnetic force. The MEMS capacitor device includes a capacitor node which includes a first surface of a first substrate of the moveable plate and a second surface of a second substrate. The capacitor node has a first capacitance when the movable plate is the open position and the capacitor node has a second capacitance when the moveable plate is in the closed position.

### BACKGROUND

A microelectromechanical system (MEMS) can be manufactured using semiconductor manufacturing techniques to produce a device that can include both mechanically activated components and electronic circuitry. Using semiconductor manufacturing techniques can permit large scale manufacturing of reliable MEMS devices in packages that resemble semiconductor devices in size and cost.

### BRIEF DESCRIPTION OF THE DRAWINGS

FIG. 1 is a block diagram of an example microelectromechanical system (MEMS) capacitor device.

FIG. 2 is a diagram of an example MEMS capacitor device movable plate.

FIG. 3 is a diagram of an example MEMS capacitor device.

FIG. 4 is a diagram of another example MEMS capacitor device.

FIG. 5 is a diagram of yet another example MEMS capacitor device.

FIG. 6 is an example process performed by the MEMS capacitor device.

### DETAILED DESCRIPTION

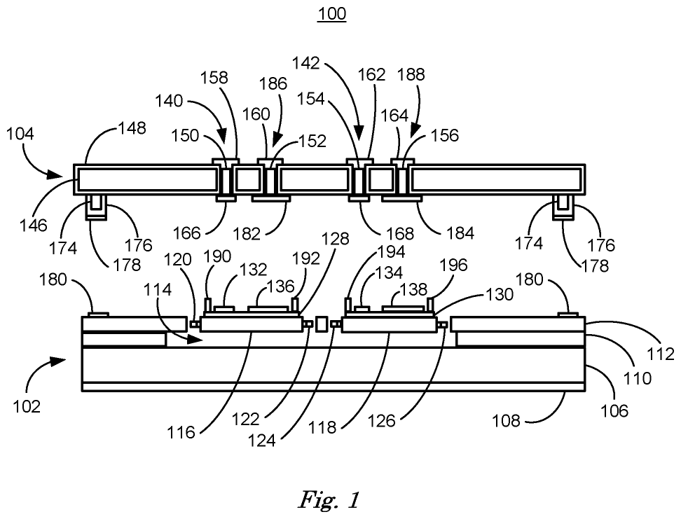

FIG. 1 is a diagram of a cross sectional view of an example MEMS variable capacitor device 100. The MEMS variable capacitor device 100 can replace standard-scale electrical devices in many applications. The MEMS variable capacitor device 100 can move one or more capacitive elements from an open position to a closed position to permit a capacitive value to change depending upon the number of capacitive elements that are activated. An advantage of the MEMS variable capacitor device 100 is that the entire device can be manufactured lithographically in a single microelectronic package, much like a semiconductor package. A dual substrate electrostatic MEMS switch device is discussed in U.S. Pat. No. 11,305,982 B2, “Eight Spring Dual Substrate MEMS Plate Switch and Method of Manufacture,” to Gudeman, et. Al., Apr. 19, 2022, which is incorporated herein by reference.

The MEMS variable capacitor device 100 can be manufactured using semiconductor lithographic techniques using semiconductor materials. Because of this, semiconductor electronics can be combined with the MEMS variable capacitor device 100 with little increase in manufacturing costs. Discussed herein are techniques for changing the capacitance seen by a signal input to a semiconductor device, replacing components which would have to be added as devices external to the semiconductor device. A MEMS variable capacitor device 100 can be fabricated to include only the capacitors or can be fabricated by integrating variable capacitor capability into a semiconductor device using the MEMS variable capacitor device 100. In either example a MEMS variable capacitor device 100 can decrease device cost and increase device reliability.

In the example shown in FIG. 1, the MEMS variable capacitor device 100 is a dual-substrate electrostatic MEMS switch device. Specifically, in such an example, the MEMS variable capacitor device 100 is fabricated on two substrates, namely a plate substrate 102 and a via substrate 104. In some examples, plate substrate 102 and via substrate 104 can be manufactured using semiconductor fabrication techniques as are known. The directions “up”, “down” and locations “top” and “bottom” are used herein to identify relative positions shown in FIG. 1.

The plate substrate 102 can be a silicon-on-insulator (SOI) substrate. Other techniques that can be used to fabricate a MEMS variable capacitor device 110 include glass wafers and polysilicon deposition. Specifically, with reference to FIG. 1, the plate substrate 102 includes a silicon handle wafer 106 and silicon dioxide layers 108, 110, namely a bottom silicon dioxide layer 108 and a top silicon dioxide layer 110. The silicon handle wafer 106 is between the silicon dioxide layers 108, 110. The silicon dioxide layers 108, 110 are insulators, i.e., are silicon dioxide insulating layers. The silicon handle wafer 106 may be thick relative to each silicon dioxide layer 108, 110. As an example, the silicon handle wafer 106 may be, or be about, 1000 μm and the silicon dioxide layers 108, 110 may each be, or be about, 10 μm.

The plate substrate 102 includes a silicon device layer 112. The silicon device layer 112 is thin relative to the silicon handle wafer 106. As an example, the silicon device layer 112 may be 20-30 μm. The silicon device layer 112 is on the top silicon dioxide layer 110 in the example shown in FIG. 1. Specifically, the silicon device layer 112 is fabricated on the top silicon dioxide layer 110. In the example shown in FIG. 1, the silicon device layer 112 is on top of the top silicon dioxide layer 110, the top silicon dioxide layer 110 is on top of the silicon handle wafer 106, and the silicon handle wafer 106 is on top of the bottom silicon dioxide layer 108. Specifically, in the example shown in FIG. 1 the silicon device layer 112 is directly on the top silicon dioxide layer 110, the top silicon dioxide layer 110 is directly on the silicon handle wafer 106, and the silicon handle wafer 106 is directly on the bottom silicon dioxide layer 108.

In some examples, including the example shown in the Figures, the silicon device layer 112 can be etched using semiconductor fabrication techniques as are known to form movable plates 116, 118 of the silicon device layer 112 by etching a void region 114 underneath and around the movable plates 116, 118. The silicon device layer 112 includes spring beam 120, 122, 124, 126 portions connecting the movable plates 116, 118 to the silicon device layer 112. Specifically, the etching of the void region 114 underneath and around the movable plates 116, 118 leaves the spring beam 120, 122, 124, 126 portions to moveably connect the silicon device layer 112 to the movable plate 116 due to the flexible nature of thin sections of silicon.

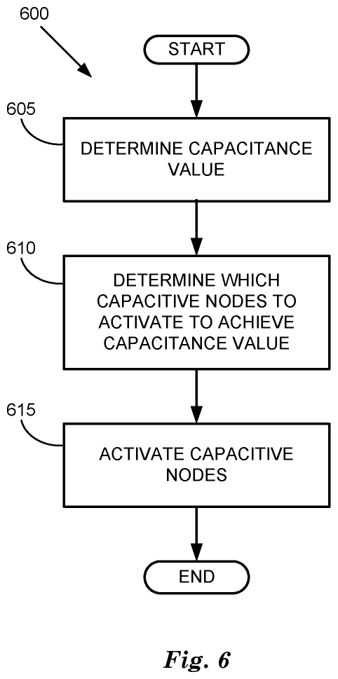

The moveable plates 116, 118 is moveable between an open position and a closed position. In an example process 600 shown in FIG. 6, the moveable plates 116, 118 are moved from the open position to the closed position in block 615, as described further below. The movable plates 116, 118 are deflectable up and down by actuating electrostatic or electromagnetic forces. The silicon device layer 112 is fabricated thinly enough so that the movable plate 116 can be deflected up and down by bending the spring beam 120, 122, 124, 126 portions. The movable plates 116, 118 can have a silicon dioxide insulating layers 128, 130 respectively, movable plate contacts 132, 134, respectively and moveable capacitive surfaces 136, 138, respectively. The moveable plates 116, 118 can also be fabricated with gap stops 190, 192, 194, 196 that define the distance that the moveable plates 116, 118 assume with respect to the via substrate 104 when the moveable plates 116, 118 are in the closed position. Other techniques for defining the distance between moveable plates 116, 118 and the via substrate 104 include depositing dielectric on the surface of the capacitor or other locations on the moveable plates 116, 118 or via substrate 104.

The MEMS variable capacitor device 100, in one example, may be activated by an electrostatic force moving one or more of the movable plates 116, 118 to the closed position. The MEMS variable capacitor device 100 is activated and de-activated by energizing or de-energizing one or more of the electrostatic elements 140, 142 included in the via substrate 104 to use electrostatic force to attract one or more of the movable plates 116, 118 towards the via substrate 104 and change the capacitive value of the MEMS variable capacitor device 100. De-energizing the electrostatic elements 140, 142 releases the moveable plates 116, 118 to the open position and returns the MEMS variable capacitor device 100 to its baseline capacitive value. Electrostatic elements 140, 142 are connected to one polarity of an electrical circuit via electronic circuitry included in the MEMS variable capacitor device 100 and the moveable plates 116 are connected to the other polarity via the standoff ring 174 and bond ring 176. When an electrical potential is applied across the circuit that includes the electrostatic elements 140, 142 and the moveable plates 116, 118, opposite electrical charges gather in the electrostatic elements 140, 142 and the moveable plates 116, 118, causing an attractive force to be generated. The attractive force causes the moveable plates 116, 118 to be drawn towards the electrostatic elements 140, 142 because the moveable plates 116, 118 is coupled to the plate substrate 102 with deformable spring beams 120, 122, 124, 126.

The via substrate 104 can include a silicon wafer 146 and a silicon dioxide insulating layer 148. The via substrate 104 includes vias 150, 152, 154, 156. Each via 150, 152, 154, 156 is a through-hole etched or drilled through the via substrate 104. Vias 150, 152, 154, 156 are filled with a conductive material, for example aluminum or copper. The vias 150, 152, 154, 156 include upper bonding pads 158, 160, 162, 164, respectively, that connect the vias 150, 152, 154, 156 to circuitry included on the via substrate 104 or to circuitry outside of the MEMS variable capacitor device 100 or lead the vias off-chip to connect to circuitry included in another device. Vias 150, 154 included in electrostatic elements 140, 142 also include via contacts 166, 168, respectively, that make electrostatic connections with movable plate contacts 132, 134 when the MEMS variable capacitor device 100 is activated.

The via substrate 104 includes a standoff ring 174 and a bond ring 176. The via substrate 104 is spaced apart from the plate substrate 102 by the standoff ring 174. Standoff ring 174 provides an operating distance between the via substrate 104 and the plate substrate 102. The operating distance can be determined by the distance that the spring beams 120, 122, 124, 126 permit the moveable plates 116, 118 to move based on the attractive force generated by the electrostatic elements 140, 142, respectively, limited by the gap stops 190, 192, 194, 196. The MEMS variable capacitor device 100 is assembled by lowering the via substrate 104 onto the plate substrate 102 and bonding the via substrate 104 to the plate substrate 102 by using pressure and elevated temperatures. The pressure and elevated temperatures form an alloy between a layer of indium 178 applied to the aluminum bond ring 176 and a layer of gold 180, applied to the plate substrate 102 to form a substantially hermetic seal. A substantially hermetic seal can retain at least about 90% of its original composition of gases for the usable life of the device. Bonding the via substrate 104 to the plate substrate 102 can include introducing gases such as sulfur hexafluoride, carbon dioxide, or freon into the cavity formed by bonding the via substrate 104 to the plate substrate 102 at pressures above or below atmospheric pressure. In some examples the cavity formed by bonding the via substrate 104 to the plate substrate 102 can be evacuated. In some examples the via substrate 104 can be bonded to the plate substrate 102 using low-outgassing epoxies.

A capacitor node 186, 188 includes the substrate capacitive surfaces 182, 184 and the moveable capacitive surfaces 136, 138. Baseline capacitance of a capacitor node 186, 188 is determined by the areas of substrate capacitive surfaces 182, 184, the areas of moveable capacitive surfaces 136, 138, and baseline distances between the substrate capacitive surfaces 182, 184 and the moveable capacitive surfaces 136, 138, respectively. Baseline distance is the distance between substrate capacitive surfaces 182, 184 and moveable capacitive surfaces 136, 138 when the moveable plates 116, 118 are in the open position. The baseline distance is determined by the height of the standoff ring 174. Setting the height of the standoff ring 174 as the MEMS variable capacitor device 100 is manufactured can determine the baseline capacitance of the capacitor nodes 186, 188.

Capacitance of the capacitor nodes 186, 188 can be changed by activating one or more electrostatic elements 140, 142 to cause one or more moveable plates 116, 118 to move one or more moveable capacitive surfaces 136, 138 closer together with respective substrate capacitive surfaces 182, 184 by moving the moveable plates 116, 118 vertically and perpendicular to the parallel surfaces of the moveable plates 116, 118 and the capacitive surfaces 136, 138. The capacitance of a particular moveable plate 116, 118 and substrate capacitive surface 182, 184 in the closed position is determined by the height of the gap stops 190, 192, 194, 196 included in the particular moveable plate 116, 118 and substrate capacitive surface 182, 184.

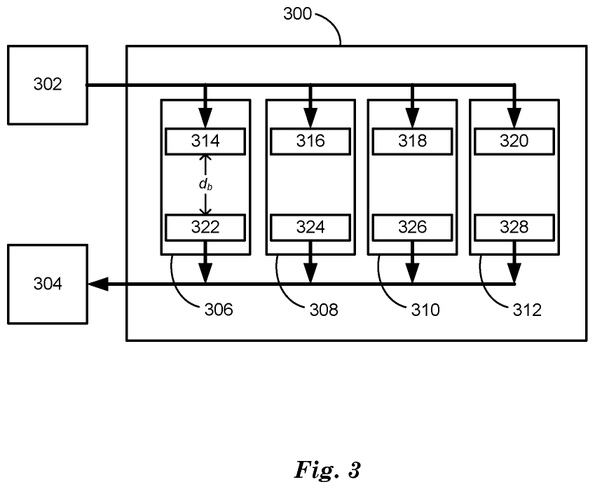

By configuring the values of the areas of substrate capacitive surfaces 182, 184, the areas of moveable capacitive surfaces 136, 138, the baseline distance, and the gap stop 190, 192, 194, 196 distances, a desired baseline capacitance for the MEMS variable capacitor device 100 can be determined. By configuring the gap stop 190, 192, 194, 196 distances, the total change in capacitance for the MEMS variable capacitor device 100 when all of the capacitor nodes 186, 188 are activated can be determined. MEMS variable capacitor devices 100 constructed according to techniques described herein can achieve a 10:1 change in capacitance between baseline capacitance and total activation capacitance. As will be described in relation to FIG. 3, intermediate values of capacitance between baseline capacitance and total activation capacitance can also be achieved by activating a portion of the capacitor nodes 186, 188.

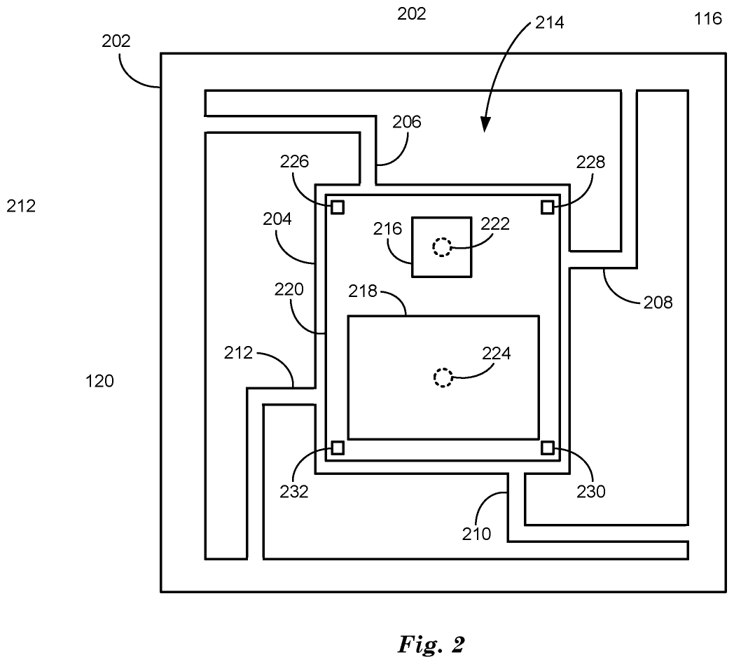

FIG. 2 is a diagram of a top-down view of a plate substrate 202. The plate substrate 202 includes one or more movable plates 204 connected to the body of the plate substrate 202 by spring beams 206, 208, 210, 212. The spring beams 206, 208, 210, 212 suspend the movable plate 204 over the void region 214, which, as described above in relation to FIG. 1, has been etched underneath and around the movable plate 204. Other configurations of spring beams 206, 208, 210 212 which suspend the moveable plate 204 are possible. The one or more moveable plates 204 each include a movable plate contact 216 and a moveable capacitive surface 218. The movable plate contact 216 and a moveable capacitive surface 218 can be electrically connected to the plate substrate 202 by vias 222, 224 (dotted lines), respectively, which can be formed by etching through an insulating silicon dioxide layer 220 on the moveable plate 204. The vias 222, 224 can connect both the movable plate contact 216 and a moveable capacitive surface 218 to ground or separately to active circuit elements included in the MEMS variable capacitor device 100.

The spring beams 206, 208, 210, 212 permit the movable plate 204 to move up and down (directions in and out of the plane of FIG. 2) in response to electrostatic or electromagnetic forces. Moving the movable plate 204 up, towards the via substrate 104 can change the capacitance of the MEMS variable capacitor device 100 by moving the moveable capacitive surface 218 closer to a substrate capacitive surface 182, 184. As described above in relation to FIG. 1, the distance between a moveable capacitive surface 218 and a substrate capacitive surface 182, 184 can be determined by gap stops 226, 228, 230, 232. Gap stops 226, 228, 230, 232 can be formed on the movable plate 204 or silicon dioxide layer 220 by depositing photoresist material or silicon dioxide.

The movable plate 204 can vibrate in a plane parallel to the diagram in FIG. 2 due to the electrostatic forces moving the movable plate 204 and the locations of the spring beams 206, 208, 210, 212. By analyzing the vibrational modes, regions of the movable plate 204 that are subject to the least vibrational motion can be determined. For example, it can be determined that by placing the moveable capacitive surface 218 on a line indicating nodes of a third-order vibrational mode of the movable plate 204, undesirable changes in capacitance due to movement of the moveable capacitive surface 218 can be minimized.

FIG. 3 is a diagram of an example MEMS variable capacitor device 300. MEMS variable capacitor device 300 is connected to an input signal 302 and an output signal 304. Capacitance generated by the MEMS variable capacitor device 300 is measured in Farads between the input signal 302 and the output signal 304. In some examples, the output signal 304 can be a ground, where the capacitance generated by MEMS variable capacitor device 300 is measured between an input signal 302 and a signal or device ground. Signal ground is a ground that is measured relative to the input signal 302 circuitry and device ground is measured relative to the entire device including external earth ground.

Capacitance C for a single parallel plate capacitor is measured in Farads is determined by the equation:

$$C = \frac{ε A}{d} \qquad ( 1 )$$

Where ε is permittivity, which measures the ability of a material to store electrical charge, A is the area of the parallel plate and d is the distance between the parallel plates. Permittivity ε is measured relative to a vacuum and can be increased by introducing other materials into the gap between the parallel plates. For example, nitride or other high-k dielectrics can be used. MEMS variable capacitor device 300 includes four capacitors The capacitance of multiple capacitors connected in parallel as in the MEMS variable capacitor device 300 is determined by adding the capacitance of each capacitor:

$${C}_{Total} = {C}_{1} + {C}_{2} + … + {C}_{N} \qquad ( 2 )$$

MEMS variable capacitor device 300 can change the total capacitance of the device by changing the distance d between the parallel plates of one or more of the capacitors formed by pairs of substrate capacitive surfaces 182, 184 and moveable capacitive surfaces 136, 138. The distance d between pairs of substrate capacitive surfaces 182, 184 and moveable capacitive surfaces 136, 138 can be changed by activating the electrostatic element 140, 142 that controls the moveable plate 116, 118 upon which the moveable capacitive surface 136, 138 is fabricated. MEMS variable capacitor device 300 advantageously changes capacitance without requiring the input signal 302 to pass through an ohmic contact, e.g., a switch. Ohmic contacts are subject to wear and corrosion which can change the resistance of the signal path and cause undesirable changes in the capacitance. Because MEMS variable capacitor device 300 does not include ohmic contacts in either the signal path or the control circuitry the operation of MEMS variable capacitor device 300 will be more reliable and maintain calibration longer than devices that include ohmic contacts.

MEMS variable capacitor device 300 includes capacitive nodes 306, 308, 310, 312. Capacitive nodes 306, 308, 310, 312 receive an input signal 302 in parallel and output a return signal 304 in parallel. The return signal 304 can be a ground. The capacitive nodes 306, 308, 310, 312 include substrate capacitive surfaces 314, 316, 318, 320, respectively, and moveable capacitive surfaces 322, 324, 326, 328, respectively. Substrate capacitive surfaces 314, 316, 318, 320, are separated from moveable capacitive surfaces 322, 324, 326, 328 by a baseline distance d_{b}. The areas of the substrate capacitive surface 314, 316, 318, 320 and the moveable capacitive surface 322, 324, 326, 328 included in a capacitive node 306, 308, 310, 312 are typically of equal area, however, the capacitive nodes 306, 308, 310, 312 do not have to be equal to each other. For example, the areas of capacitive nodes 306, 308, 310, 312 can be increased by factors of two to permit binary-weighted coarse and fine adjustment of capacitance.

By varying the areas of the substrate capacitive surfaces 314, 316, 318, 320 and the moveable capacitive surfaces 322, 324, 326, 328 included in the capacitive nodes 306, 308, 310, 312, the change in capacitive value caused by activating a single capacitive node 306, 308, 310, 312 can differ. For example, increasing the area of one or more capacitive nodes 306, 308, 310, 312 can increase the amount of capacitance added to the overall capacitance of the MEMS variable capacitor device 100 when the increased area capacitive node 306, 308, 310, 312 is activated which can increase the total range of capacitance. Decreasing the area of one or more capacitive nodes 306, 308, 310, 312 can decrease the amount of capacitance added to the total capacitance of the MEMS variable capacitor device 100 when the decreased area capacitive node 306, 308, 310, 312 is activated which can increase the precision with which capacitance is changed while decreasing the range.

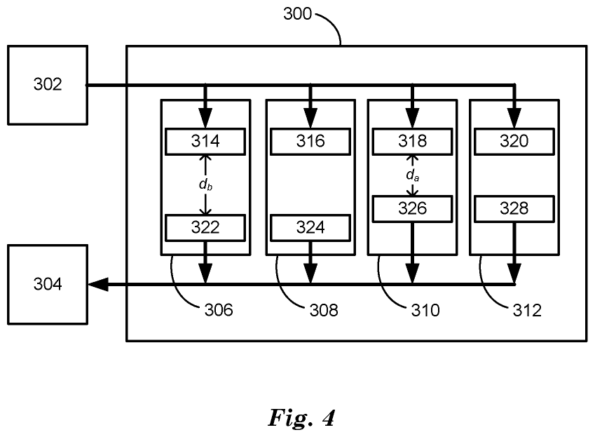

FIG. 4 is a diagram of a MEMS variable capacitor device 300 where two capacitive nodes 310, 312 are activated decreasing the distance between substrate capacitive surfaces 318, 320 and the moveable capacitive surfaces 326, 328 to activated distance dₐ, while two capacitive nodes 310, 312 remain at baseline distance d_{b}. Because, according to Equation (2), the total capacitance applied to input signal 302 is the sum of capacitances for capacitive nodes 306, 308, 310, 312, the total capacitance will be greater than the baseline capacitance and less than the largest capacitance value that MEMS variable capacitor device 300 is capable of.

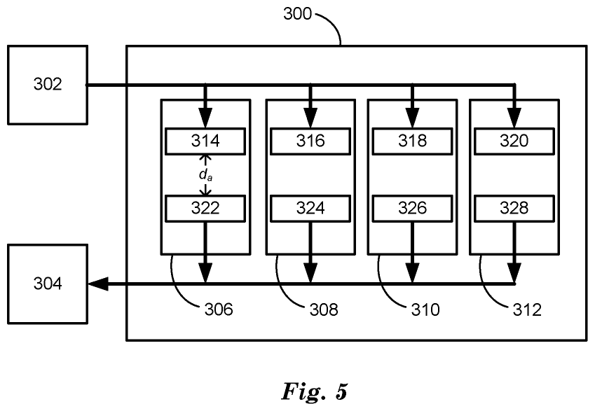

FIG. 5 is a diagram of a MEMS variable capacitor device 300 where all of the capacitive nodes 306, 308, 310, 312 are activated, decreasing the distances between capacitive surfaces 314, 316, 318, 320 and the moveable capacitive surfaces 322, 324, 326, 328 to activated distance dₐ. Because, according to Equation (2), the total capacitance applied to input signal 302 is the sum of capacitances for capacitive nodes 306, 308, 310, 312, the total capacitance will be the maximum capacitance available in MEMS variable capacitor device 300. As described above in relation to FIG. 1, the maximum capacitance available to a MEMS variable capacitor device 300 depends upon the areas of capacitive surfaces 314, 316, 318, 320 and the moveable capacitive surfaces 322, 324, 326, 328 and the activated distance dₐ.

FIG. 6 is a diagram of an example process 600 performed by the MEMS variable capacitor device 100. Use of “in response to,” “based on,” and “upon determining” herein, including with reference to the example process 600, indicates a causal relationship, not merely a temporal relationship.

As set forth above, the process 600 includes moving one or more movable plates 116, 118 from the open position to the closed position, as shown in block 615 and as described above. As an example, the one or more moveable plates 116, 118 may be moved by applying an electrostatic force to move the one or more movable plates 116, 118 to the closed position, as described above. The process 600 includes inputting an input signal 302 to the capacitive nodes 306, 308, 310, 312 of a MEMS variable capacitor device 300.

The process 600 includes determining a capacitive value at block 605. The capacitive value be determined by circuitry included in the MEMS variable capacitor device 300 or supplied by a process outside of the MEMS variable capacitor device 300. The capacitive value can be checked to ensure that it falls within the range between the baseline capacitance and the maximum capacitance of MEMS variable capacitor device 300.

At block 610 the process 600 select which capacitive nodes 306, 308, 310, 312 to activate to achieve the capacitive value determined at block 605. Which capacitive nodes 306, 308, 310, 312 to activate can be determined by adding the increase in capacitance due to activating each capacitive nodes 306, 308, 310, 312 one at a time until the desired capacitive value is reached. In examples where the capacitive nodes 306, 308, 310, 312 differ in capacitance, various combinations of capacitive nodes 306, 308, 310, 312 can be tried to reach the desired capacitive value most closely.

At block 615 the selected capacitive nodes 306, 308, 310, 312 are activated to achieve the desired capacitance for MEMS variable capacitor device 300. Following block 615 process 600 ends.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain example embodiments.

1. A microelectromechanical systems (MEMS) capacitor device, comprising:
a movable plate movable between an open position and a closed position by an electrostatic force and/or a magnetic force;
a capacitor node which includes a first surface of a first substrate of the moveable plate and a second surface of a second substrate;
the capacitor node having a first capacitance when the movable plate is the open position; and
the capacitor node having a second capacitance when the moveable plate is in the closed position.

2. The MEMS capacitor device of claim 1, further comprising a plurality of the capacitor nodes.

3. The MEMS capacitor device of claim 2, wherein the first surfaces of two or more of the capacitive nodes are connected to a signal path.

4. The MEMS capacitor device of claim 3, wherein the second surfaces of two or more capacitive nodes are connected to a ground.

5. The MEMS capacitor device of claim 1, wherein the movable plate is movable to the closed position by activation of one or more of an electrostatic force or an electromagnetic force.

6. The MEMS capacitor device of claim 1, wherein the first capacitance is determined by a first area of the first surface, a second area of the second surface, and a first distance between the first surface and the second surface when the moveable plate is in the open position.

7. The MEMS capacitor device of claim 6, wherein the second capacitance is determined by the first area of the first surface, second area of the second surface, and a second distance between the first surface and the second surface when the moveable plate is in the closed position, the first distance being greater than the second distance.

8. The MEMS capacitor device of claim 7, wherein the moveable plate includes gap stops to define the second distance between the first surface and the second surface when the moveable plate is in the closed position.

9. The MEMS capacitor device of claim 1, wherein one or more movable plates are coupled to the first substrate via two or more spring beams.

10. The MEMS capacitor device of claim 1, wherein the second capacitance is determined by a first area of the first surface, a second area of the second surface, and a distance between the first surface and the second surface when the moveable plate is in the closed position.

11. The MEMS capacitor device of claim 1, wherein the movable plate includes gap stops to define a distance between the first surface and the second surface when the moveable plate is in the closed position.

12. The MEMS capacitor device of claim 1, wherein the movable plate is moveable relative to the second substrate between the open position and the closed position.

13. The MEMS capacitor device of claim 12, wherein the first substrate is spaced from the second substrate by a first distance in the open position and by a second distance in the closed position, the first distance being greater than the second distance.

14. The MEMS capacitor device of claim 13, wherein the movable plate includes gap stops to define the second distance between the first surface and the second surface when the moveable plate is in the closed position.

15. The MEMS capacitor device of claim 1, wherein electronic circuitry is included in one or more of the MEMS capacitor device or another device.

16. The MEMS capacitor device of claim 1, wherein a dielectric material is included in an air gap between the first surface and the second surface.

17. A method comprising:
changing a capacitance of a capacitor node included in a microelectromechanical systems (MEMS) capacitor device from a first capacitance to a second capacitance by:
moving a movable plate movable between an open position and a closed position by an electrostatic force and/or a magnetic force;
wherein the capacitor node includes a first surface of a first substrate of the moveable plate and a second surface of a second substrate;
the capacitor node having a first capacitance when the movable plate is the open position; and
the capacitor node having a second capacitance when the moveable plate is in the closed position.

18. The method of claim 17, wherein the MEMS capacitor device includes a plurality of the capacitor nodes.

19. The method of claim 18, wherein the first surfaces of the plurality of the capacitive nodes are connected to a signal path.

20. The method of claim 19, wherein the second surfaces of the plurality of capacitive nodes are connected to a ground.
